(19) United States
(12) Patent Application Publication
(10) Pub. No.: US 2025/0370949 A1
(43) Pub. Date: Dec. 4, 2025

(54) DECOUPLING PROCESSING AND INTERFACE CLOCKS IN AN IPU

(71) Applicant: XILINX, INC., San Jose, CA (US)

(72) Inventors: Juan J. NOGUERA SERRA, San Jose, CA (US); Sneha Bhalchandra DATE, San Jose, CA (US); Tim TUAN, San Jose, CA (US)

(21) Appl. No.: 18/679,361

(22) Filed: May 30, 2024

(51) Int. Cl. G06F 13/40; G06F 1/06

(52) U.S. Cl. CPC G06F 13/4068; G06F 1/06

(57) ABSTRACT

Embodiments herein describe a hardware accelerator that includes multiple clock domains. For example, the hardware accelerator can include data processing engines (DPEs) which include circuitry for performing acceleration tasks (e.g., artificial intelligence (AI) tasks, data encryption tasks, data compression tasks, and the like). The DPEs are interconnected to permit them to share data when performing the acceleration tasks. In addition to the DPEs, the hardware accelerator can include interface circuitry such as an interconnect, a controller, address translation circuitry, etc. The DPEs may be in a first clock domain while the other circuitry is in a second clock domain. The two clock domains can use different frequency clock circuits, for example, to generate more bandwidth for moving data into and out of the hardware accelerator while reducing power consumption.

### TECHNICAL FIELD

Examples of the present disclosure generally relate to establishing different clock domains in a same system on a chip (SoC).

### BACKGROUND

Typically, a hardware accelerator is an input/output (IO) device that is communicatively coupled to a central processing unit (CPU) via a PCIe connection. The CPU and hardware accelerator can use direct memory access (DMA) and other communication techniques to share data.

The SoC can include any number of circuit blocks which can form a heterogeneous processing system. For example, the SoC can include one or more CPUs, one or more graphics processing units (GPUs), programmable logic (PL), one or more microprocessors or microcontrollers, and accelerators. The SoC can include a SoC interface (e.g., a network on chip (NoC)) that interconnects the different components in the heterogeneous processing system. The bandwidth between the NoC and the various components can be a bottleneck since if bandwidth is low, the component (e.g., CPU, GPU, PL, accelerator, etc.) can become data starved, or may have to stop processing while waiting for already processed data to be moved out of the component.

### SUMMARY

One embodiment described herein is a system on a chip (SoC) that includes a hardware accelerator including data processing engines (DPEs) and interface circuitry where the DPEs are in a first clock domain that uses a first clock and the interface circuitry is in a second clock domain that uses a second clock with a different frequency than the first clock, and an interface communicatively coupling the hardware accelerator to other circuitry in the SoC.

One embodiment described herein is a method that includes providing a hardware accelerator including DPEs in a first clock domain and interface circuitry in a second clock domain, operating a first clock in the first clock domain at a first frequency, and operating a second clock in the second clock domain at a second frequency different from the first frequency.

One embodiment described herein is a system that includes an integrated circuit (IC) that includes a hardware accelerator comprising first circuitry in a first clock domain and interface circuitry in a second clock domain, wherein, during operation, a first clock in the first clock domain has lower frequency than a second clock in the second clock domain and a memory controller. The system also includes at least one memory coupled to the memory controller in the IC.

### BRIEF DESCRIPTION OF DRAWINGS

So that the manner in which the above recited features can be understood in detail, a more particular description, briefly summarized above, may be had by reference to example implementations, some of which are illustrated in the appended drawings. It is to be noted, however, that the appended drawings illustrate only typical example implementations and are therefore not to be considered limiting of its scope.

FIG. 1 illustrates a SoC with an AI accelerator, according to an example.

FIGS. 2A and 2B illustrate AI accelerators with different clock domains, according to an example.

FIG. 3 illustrates a SoC with different clock domains, according to an example.

FIG. 4 illustrates an integrated circuit with different clock domains, according to an example.

FIG. 5 illustrates a workflow for operating clock domains in a hardware accelerator, according to an example.

FIG. 6 is a block diagram of a data processing engine, according to an example.

FIG. 7 is a block diagram of an AI engine array, according to an example.

To facilitate understanding, identical reference numerals have been used, where possible, to designate identical elements that are common to the figures. It is contemplated that elements of one example may be beneficially incorporated in other examples.

### DETAILED DESCRIPTION

Various features are described hereinafter with reference to the figures. It should be noted that the figures may or may not be drawn to scale and that the elements of similar structures or functions are represented by like reference numerals throughout the figures. It should be noted that the figures are only intended to facilitate the description of the features. They are not intended as an exhaustive description of the embodiments herein or as a limitation on the scope of the claims. In addition, an illustrated example need not have all the aspects or advantages shown. An aspect or an advantage described in conjunction with a particular example is not necessarily limited to that example and can be practiced in any other examples even if not so illustrated, or if not so explicitly described.

Embodiments herein describe a hardware accelerator that includes multiple clock domains. For example, the hardware accelerator can include an array of data processing engines (DPEs) which include circuitry for performing acceleration tasks (e.g., artificial intelligence (AI) tasks, data encryption tasks, data compression tasks, and the like). The DPEs are interconnected to permit them to share data when performing the acceleration tasks. In addition to the DPEs, the hardware accelerator can include other circuitry such as an interconnect (e.g., a network on a chip (NoC)), a controller, address translation circuitry, etc. The DPEs may be in a first clock domain while the other circuitry is in a second clock domain. That way, a clock that operates the DPE can have a different frequency than the clock for the other circuitry. As mentioned above, an interface between a component in a SoC (e.g., the hardware accelerator) and a SoC interconnect (e.g., the NoC) can have limited bandwidth. This means that the hardware accelerator may not be able to move data in, or move data out, as fast as the accelerator can process the data.

Increasing the clock frequency increases the bandwidth at the interface, but this comes at a cost of using more voltage/power. Instead of increasing the clock frequency for the entire hardware accelerator, the embodiments herein divide the hardware accelerator into at least two clock domains. The frequency of the clock domain that includes the interface circuitry in the accelerator can be increased to increase the bandwidth while the frequency of the clock domain that includes the remaining circuitry (e.g., the DPEs) can be a lower frequency. This save power relative to increasing the clock frequency for the entire hardware accelerator.

In one embodiment, the hardware accelerator is integrated into a same SoC (or same chip or integrated circuit (IC)) as a CPU. Thus, instead of relying on off-chip communication techniques, on-chip communication techniques such as an interconnect (e.g., a NoC) can be used to facilitate communication between the hardware accelerator and the CPU. This can result in faster communication between the hardware accelerator and the CPU. Moreover, a tighter integration between the CPU and hardware accelerator can make it easier for the CPU to offload tasks to the hardware accelerator.

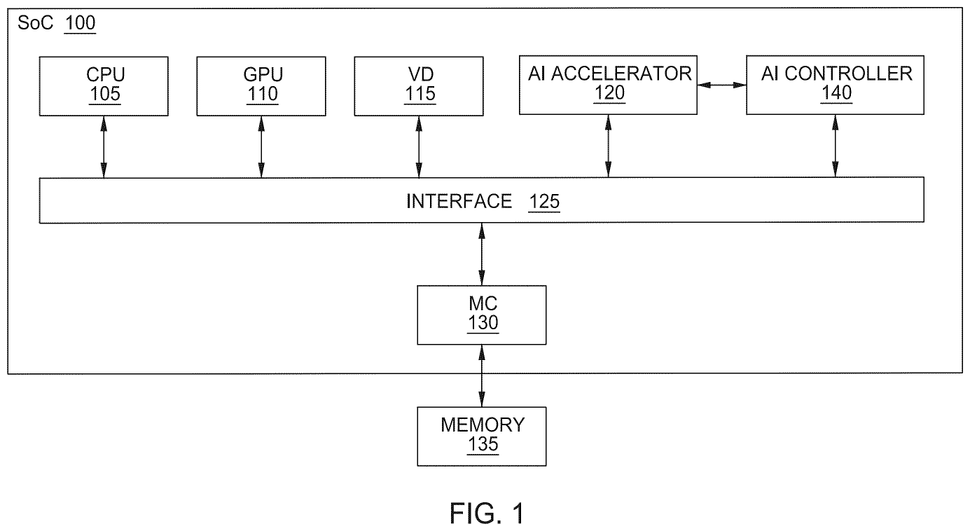

FIG. 1 illustrates a SoC 100 with an AI accelerator 120, according to an example. The SoC 100 can be a single IC or a single chip. In one embodiment, the SoC 100 includes a semiconductor substrate on which the illustrated components are formed using fabrication techniques.

The SoC 100 includes a CPU 105, GPU 110, video decoder (VD) 115, AI accelerator 120, AI controller 140, interface 125, and memory controller (MC) 130. However, the SoC 100 is just one example of integrating an AI accelerator 120 and AI controller 140 into a shared platform with the CPU 105. In other examples, a SoC may include fewer components than what is shown in FIG. 1. For example, the SoC may not include the VD 115 or an internal GPU 110. However, in other examples, the SoC may include additional components than the ones shown in FIG. 1. Thus, FIG. 1 is just one example of components that can be integrated into a SoC with the AI accelerator 120 and the AI controller 140.

The CPU 105 can represent any number of processors where each processor can include any number of cores. For example, the CPU 105 can include processors arranged in array, or the CPU 105 can include an array of cores. In one embodiment, the CPU 105 is an x86 processor that uses a corresponding complex instruction set. However, in other embodiments, the CPU 105 may be other types of CPUs such as an Advanced Reduced Set Instruction Computer (RSIC) Machine (ARM) processor.

The GPU 110 is an internal GPU 110 that performs accelerated computer graphics and image processing. The GPU 110 can include any number of different processing elements. In one embodiment, the GPU 110 can perform non-graphical tasks such as training an AI model or cryptocurrency mining.

The VD 115 can be used for decoding and encoding videos.

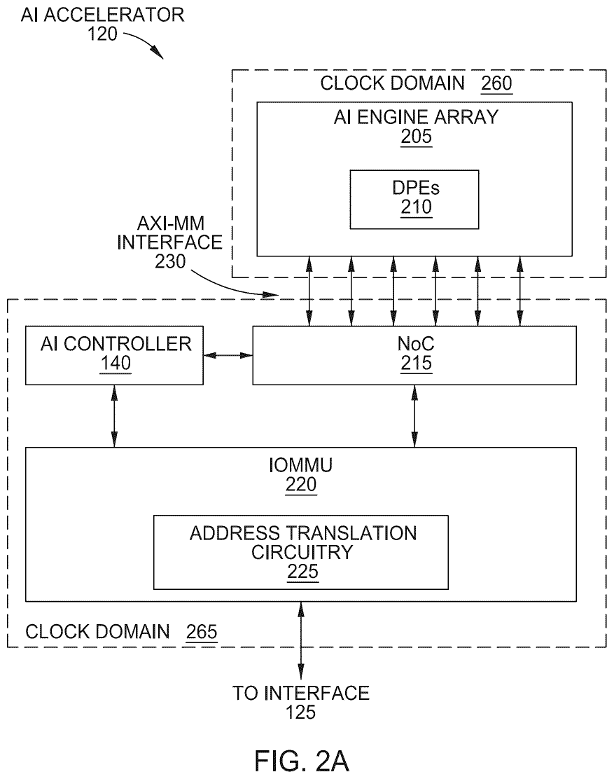

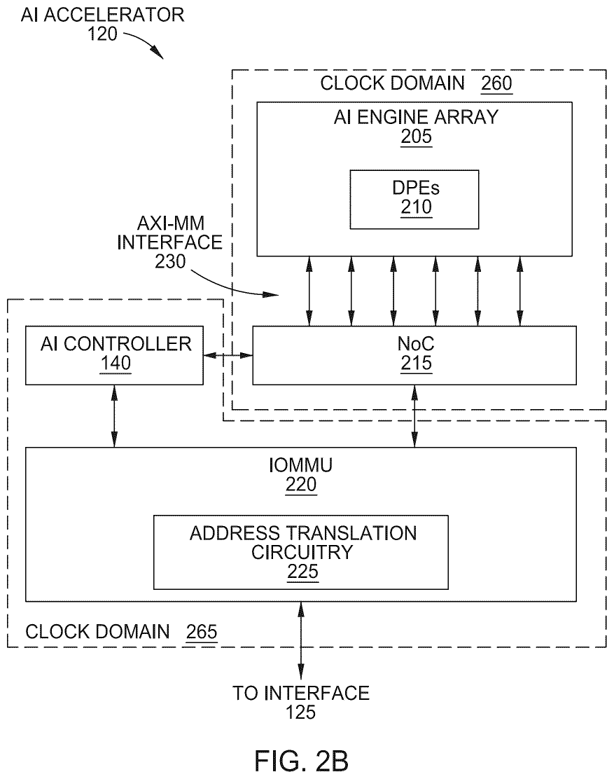

The AI accelerator 120 can include any hardware circuitry that is designed to perform AI tasks, such as inference. In one embodiment, the AI accelerator 120 includes an array of DPEs that performs calculations that are part of an AI task. These calculations can include math operations or logic operations (e.g., bit shifts and the like). The details of two implementations of the AI accelerator 120 are discussed in FIGS. 2A and 2B.

The AI controller 140 is shown as being separate from the AI accelerator 120, but can be considered as part of the AI accelerator 120. In this example, the AI controller 140 has its own data connection to the interface 125. As such, the CPU 105 can transmit instructions to the AI controller 140 to perform an AI task. The AI controller 140 is also communicatively coupled to the AI accelerator 120 so the controller 140 can configure the DPEs in the accelerator 120 to perform the task (e.g., an inference or training task). Further, the AI controller 140 can use the interface 125 to communicate with the CPU 105, such as informing the CPU 105 when an AI task is complete.

In one embodiment, the AI controller 140 is a microprocessor, and as such, is separate from the CPU 105. The AI controller 140 can be hardened circuitry that executes software code (or firmware) that controls the AI accelerator 120. In one embodiment, the only task of the AI controller 140 is to control and orchestrate the functions performed by the AI accelerator 120. However, in other embodiments, other tasks may be performed by the AI controller 140, such as moving data into and out of the AI accelerator. For example, the AI controller 140 may communicate with the MC 130 to store data in, or retrieve data from, the memory 135. In another example, if there are currently no AI tasks to perform, the AI controller 140 may be used to do tasks that are unrelated to AI, such as serving as an ancillary processor for the CPU 105. In this example, the AI controller 140 may execute different specialized code depending on the task the CPU 105 has currently assigned to it. Further details of the AI accelerator 120 and the AI controller 140 are provided in the figures below.

The SoC 100 also includes one or more MCs 130 for controlling memory 135 (e.g., random access memory (RAM)). While the memory 135 is shown as being external to the SoC 100 (e.g., on a separate chip or chiplet), the MCs 130 could also control memory that is internal to the SoC 100.

The CPU 105, GPU 110, VD 115, AI accelerator 120, AI controller 140, and MC 130 are communicatively coupled using an interface 125. Put differently, the interface 125 permits the different types of circuitry in the SoC 100 to communicate with each other. For example, the CPU 105 can use the interface 125 to instruct the AI controller 140 to perform an AI task. The AI accelerator 120 and/or the controller 140 can use the interface 125 to retrieve data (e.g., input for the AI task) from the memory 135 via the MC 130, process the data to generate a result, store the result in the memory 135 using the interface 125, and then inform the CPU 105 that the AI task is complete using the interface 125.

In one embodiment, the interface 125 is a NoC, but other types of interfaces such as internal buses are also possible.

FIG. 2A illustrates the AI accelerator 120, according to an example. The AI accelerator 120 can also be described as an inference processing unit (IPU) but is not limited to performing AI inference tasks.

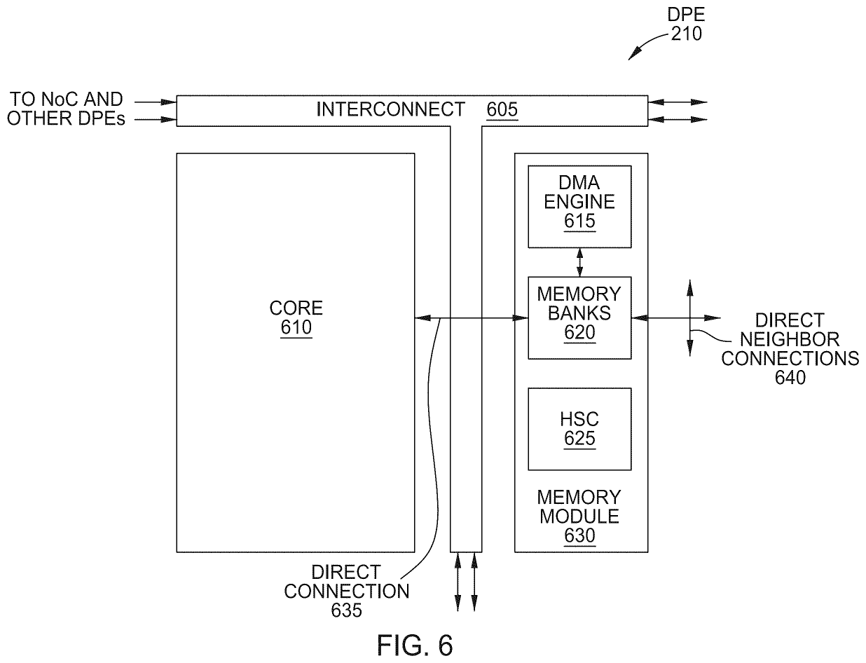

The accelerator 120 includes an AI engine array 205 that includes a plurality of DPEs 210 (which can also be referred to as AI engines). The DPEs 210 may be arranged in a grid, cluster, or checkerboard pattern in the SoC 100 in FIG. 1—e.g., a 2D array with rows and columns. Further, the array 205 can be any size and have any number of rows and columns formed by the DPEs 210. One example layout of the array 205 is shown in FIG. 6.

In one embodiment, the DPEs 210 are identical. That is, each of the DPEs 210 (also referred to as tiles or blocks) may have the same hardware components or circuitry. In one embodiment, the array 205 includes DPEs 210 that are all the same type (e.g., a homogeneous array). However, in another embodiment, the array 205 may include different types of engines.

Regardless if the array 205 is homogenous or heterogeneous, the DPEs 210 can include direct connections between DPEs 210 which permit the DPEs 210 to transfer data directly to neighboring DPEs. Moreover, the array 205 can include a switched network that uses switches that facilitate communication between neighboring and non-neighboring DPEs 210 in the array 205.

In one embodiment, the DPEs 210 are formed from software-configurable hardened logic—i.e., are hardened. One advantage of doing so is that the DPEs 210 may take up less space in the SoC relative to using programmable logic to form the hardware elements in the DPEs 210. That is, using hardened logic circuitry to form the hardware elements in the DPE 210 such as program memories, an instruction fetch/decode unit, fixed-point vector units, floating-point vector units, arithmetic logic units (ALUs), multiply accumulators (MAC), and the like can significantly reduce the footprint of the array 205 in the SoC. Although the DPEs 210 may be hardened, this does not mean the DPEs 210 are not programmable. That is, the DPEs 210 can be configured when the SoC is powered on or rebooted to perform different AI functions or tasks.

While an AI accelerator 120 is shown, the embodiments herein can extend to other types of integrated accelerators. For example, the accelerator could include an array of DPEs for performing other tasks besides AI tasks. For instance, the DPEs 210 could be digital signal processing engines, cryptographic engines, Forward Error Correction (FEC) engines, or other specialized hardware for performing one or more specialized hardware acceleration tasks. In that case, the accelerator could be a cryptography accelerator, compression accelerator, and so forth.

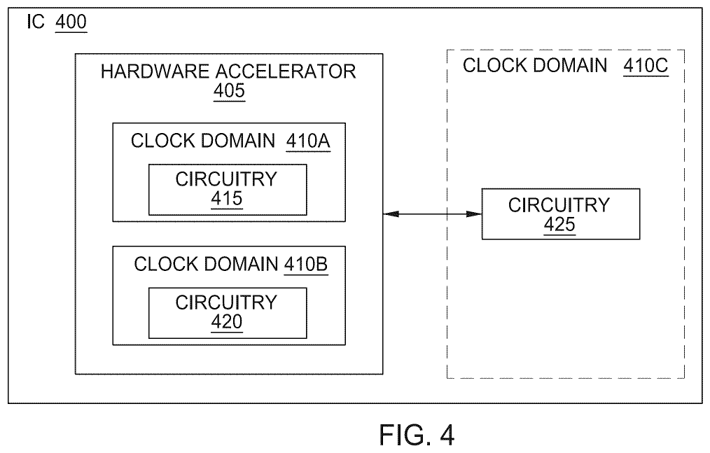

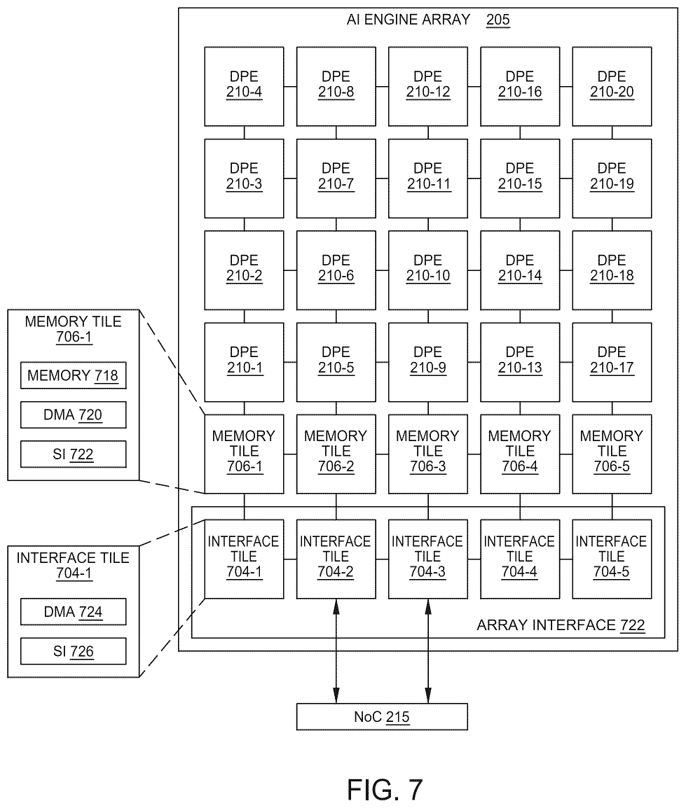

In this example, the DPEs 210 in the array 205 use the Advanced extensible Interface (AXI) memory-mapped (MM) interface 230 to communicate with a NoC 215. AXI is an on-chip communication bus protocol that is part of the Advanced Microcontroller Bus Architecture (AMBA) specification. An AXI MM interface 230 is used (rather than a AXI streaming interface) to transfer data between the DPEs 210 and the NoC 215 to access external memory, which uses physical memory addresses. As discussed in FIG. 4 below, the DPEs can communicate with each other using a streaming protocol or interface (e.g., AXI streaming which does not use memory addresses) but a memory mapped protocol or interface (e.g., AXI MM) is used when transmitting data external to the array 205. In one embodiment, the array 205 can include interface tile (such as the interface tile 704 discussed in FIG. 7) that include primary and secondary DMA interfaces for transmitting data into and out of the array. When receiving data from the NoC 215, the interface tiles in the array 205 can transform the data into AXI streaming data.

In one embodiment, a memory mapped interface is also used to communicate between the NoC 215 and the IOMMU 220, and between the IOMMU 220 and the interface 125. However, these interfaces may be different types of memory mapped interfaces. For example, the interface between the NoC 215 and the IOMMU 220 may be AXI-MM, while the interface between the IOMMU 220 and the interface 125 is a different type of memory mapped interface. While AXI is discussed as one example herein, any suitable memory mapped and streaming interfaces may be used.

The NoC 215 may be a smaller interface than the interface 125 in FIG. 1. For example, the NoC 215 may be a miniature NoC when compared to using a NoC to implement the interface 125 in FIG. 1. The NoC 215 permits the DPEs 210 in the different columns of the AI engine array 205 to communicate with an Input-Output Memory Management Unit (IOMMU) 220. The NoC 215 can include a plurality of interconnected switches. For example, the switches may be connected to their neighboring switches using north, east, south, and west connections.

In one embodiment, the data in the AI accelerator 120 is tracked using virtual memory addresses. However, other circuitry in the SoC 100 (e.g., caches in the CPUs 105, memory in the GPUs 110, the MC 130, etc.) may use physical memory addresses to store the data. The IOMMU 220 includes address translation circuitry 225 to perform memory address translation on data that flows into, and out of, the AI accelerator 120. For example, when receiving data from other circuitry in the SoC (e.g., from the MCs 130) via the interface 125, the address translation circuitry 225 may perform a physical-to-virtual address translation. When transmitting data from the AI accelerator 120 to be stored in the SoC or external memory 135 using the interface 125, the address translation circuitry 225 performs a virtual-to-physical address translation. For example, when using AXI-MM, the address translation circuitry 225 performs a translation between AXI-MM virtual addresses to physical addresses used to store the data in external memory or caches. While FIG. 2A illustrates using an IOMMU, the address translation function may be implemented using any suitable type of address translation circuitry.

FIG. 2A also includes the AI controller 140 which is coupled to the NoC 215. As mentioned above, the AI controller 140 is a processor (e.g., a light-weight processor when compared to the CPU) which controls the DPEs 210. For example, the AI controller 140 may program or configure the DPEs 210 to perform an inference AI task. This may include configuring the DPEs 210 to perform a series of operations. For instance, the DPEs 210 may pass data between them in order to perform the AI task.

In this example, the AI controller 140 relies on the NoC 215 to communicate to, and configure, the DPEs 210. After the DPEs 210 have performed the task, the AI controller 140 can inform the CPU using the interface 125, via the IOMMU 220. However, in other embodiments, rather than communicating through the IOMMU 220 to reach the interface 125, the AI controller 140 may bypass the IOMMU 220 when communicating with the interface 125.

Further, a controller may be used even when the accelerator is not an AI accelerator. For example, any type of accelerator (e.g., cryptography accelerator or compression accelerator) that has an array of DPEs 210 can rely on a controller 140 to orchestrate the DPEs to perform acceleration tasks assigned by the CPU. Thus, while an AI accelerator and controller are shown in FIGS. 1 and 2, the embodiments herein are not limited to such and can apply to any type of accelerator with DPEs.

In this embodiment, the components (e.g., circuitry) in the AI accelerator 120 are divided into two different clock domains. As shown, the AI engine array 205, which includes the DPEs 210, are in a first clock domain 260 while the AI controller 140, the NoC 215, and the IOMMU 220 are in a second clock domain 265. Placing the circuitry in different clock domains permit the SoC to use clocks with different frequencies in the two clock domains. For example, if the IOMMU 220 currently has a large amount of data to move into, or out of, the AI accelerator 120, the SoC may increase the frequency of the clock domain 265. In that case, the clock in the clock domain 265 may have a higher frequency than the clock in the clock domain 260 that operates the AI engine array 205. In contrast, if the IOMMU 220 does not have much data to move, the SoC may reduce the frequency of the clock in the clock domain 265. In that case, the clock may have a frequency that is lower (or the same) as the clock in the clock domain 260.

In a static embodiment, rather than adjusting the clock of the clock domain 265 dynamically in response to data movement demands, the SoC may always use a clock with a higher clock frequency for the clock domain 265 than the clock domain 260. That is, in this embodiment, the frequencies of the clocks in the domains may be fixed where the clock of the domain 265 has a higher frequency than the clock in the domain 260. This may use more power than a dynamic embodiment, but may also use less processing power or less circuitry to monitor and control the clock in the clock domain 265. In any case, using two separate clock domains can enable the AI accelerator 120 to use a faster clock to result in greater bandwidth when exchanging data with the interface 125, without also forcing the AI engine array 205 to use the higher clock, thereby saving power. These power savings may be notable since there may be much more circuitry in the clock domain 260 (e.g., circuitry implementing the AI engine array 205) than circuitry in the clock domain 265 (e.g., the circuit implementing the AI controller 140, NoC 215, and IOMMU 220).

Further, while two clock domains are shown, the AI accelerator 120 may be divided into more than two clock domains. For example, the AI engine array 205 may be in a first clock domain, the AI controller 140 may be in a second clock domain, and the NoC 215 and the IOMMU 220 may be in a third clock domain. In a dynamic embodiment, at one point in time, these three clock domains can each use a clock with a different frequency, while at another point in time, the three clock domains use a clock with the same frequency. In a static embodiment, the three clock domains can always use different frequency clocks.

Further, while FIG. 2A illustrates interface circuitry implemented using an IOMMU, in another embodiment, a memory protection circuit could be used instead that does not perform the address translation like an IOMMU but limits the data that is accessible by the AI accelerator 120. For example, the memory protection circuit allows the memory requests from the AI engine array 205 to access only particular memory ranges.

FIG. 2B illustrates the same components as in FIG. 2A but with a different boundary of the clock domains. Here, the clock domain 260 includes the NoC 215 which was included in the clock domain 265 in FIG. 2A. Thus, in this example, the NoC 215 and the AI engine array 205 receive a clock at the same frequency while the AI controller 140 and the IOMMU 220 can receive a clock at a different frequency. FIGS. 2A and 2B are just two examples of implementing different clock domains in a hardware accelerator. The components could be divided differently than shown, or there may be more (different) clock domains.

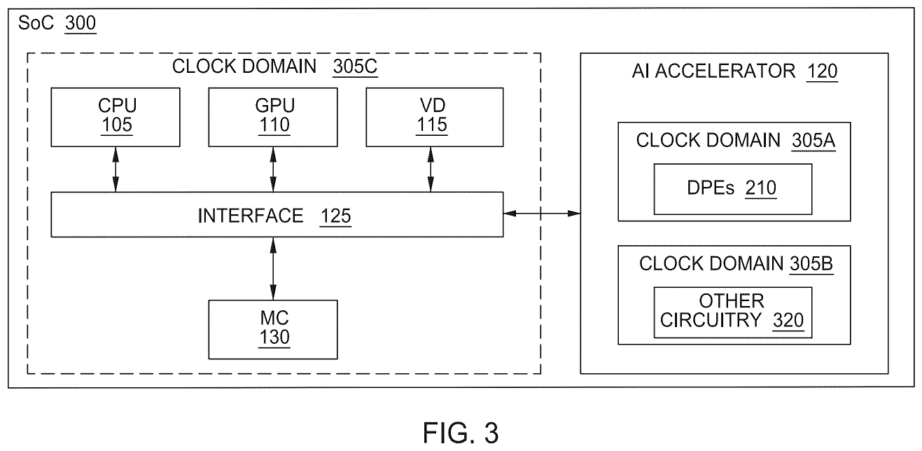

FIG. 3 illustrates a SoC 300 with different clock domains, according to an example. The SoC 300 has many of the same components as shown in the SoC 100 in FIG. 1, which is indicated by using the same reference numbers. In addition, the SoC 300 illustrates that the circuitry in the SoC 300 separate from the AI accelerator 120 can be assigned to different clock domains 305.

In this example, the AI accelerator 120 is divided into at least two clock domains—i.e., clock domains 305A and 305B. The clock domain 305A includes the DPEs 210, but can include other circuitry in the AI accelerator 120. That is, the clock domain 305A includes at least the array of DPEs 210 shown in FIG. 2A, but can include other circuitry.

The clock domain 305B in the AI accelerator 120 includes other circuitry 320 in the AI accelerator 120—i.e., other circuitry besides the DPEs 210. For example, the clock domain 305B can include a controller, NoC, IOMMU, and the like. As discussed in FIG. 2A, by dividing the circuitry in the AI accelerator 120 into different clock domains 305A and 305B, this permits the DPEs 210 and the other circuitry 320 to be driven using different frequency clocks. Of course, the AI accelerator 120 may be able to adjust the clock frequencies so that the clock domains 305A and 305B have the same clock.

In this example, the remaining circuitry in the SoC 300—i.e., the circuitry that is not in the AI accelerator 120—is disposed in the clock domain 305C. Thus, the SoC 300 can operate one, or both, of the clock domains 305A and 305B in the AI accelerator 120 using different clocks without affecting the clock used by the circuitry in the clock domain 305C (i.e., the CPU 105, the GPU 110, the VD 115, the interface 125, and the MC 130). While FIG. 3 illustrates placing the CPU 105, the GPU 110, the VD 115, the interface 125, and the MC 130 in the clock domain 305C, these components may also be disposed in different clock domains (e.g., the VD 115 or the GPU 110 may be disposed in a clock domain different from the CPU 105) so they can be selectively turned off

Further, in an alternative embodiment, the circuitry in the AI accelerator 120 may be disposed in the same clock domain as circuitry that is separate from the AI accelerator 120. For example, the other circuitry 320 in the AI accelerator 120 may be part of the clock domain 305C. In that case, the SoC 300 may have only two clock domains, where the first clock domain 305A includes the DPEs 210 while the remaining circuitry in the SoC 300 is in a second clock domain. For instance, the controller, NoC, and IOMMU in the AI accelerator 120 can be in the same clock domain as the CPU 105, GPU 110, VD, 115, interface 125, and the MC 130.

FIG. 4 illustrates an IC 400 with different clock domains 410, according to an example. The IC 400 includes a hardware accelerator 405 and circuitry 425. The hardware accelerator 405 can be an AI accelerator, encryption accelerator, compression accelerator, and the like.

The hardware accelerator 405 includes circuitry 415 disposed in a first clock domain 410A and circuitry 420 disposed in a second clock domain 410B. For example, the circuitry 415 may include one or more DPEs (or other type of computing unit) in the first clock domain 410A while the circuitry 420 includes a different type of circuitry (e.g., a controller/orchestrator, interconnect, NoC, or IOMMU). Thus, in one embodiment, the circuitry 415 can include one type of circuitry while the circuitry 420 includes a different type of circuitry 420 in the hardware accelerator 405. As such, the embodiments herein include putting different types of circuitry in different clock domains 410, regardless whether that circuitry includes DPEs or some other type of compute unit. Further, the embodiments herein can apply to different types of hardware accelerators, not just AI accelerators.

In addition, FIG. 4 illustrates that the hardware accelerator 405 can be integrated into the same IC 400 as the circuitry 425, which is in clock domain 410A. The circuitry 425 can include another accelerator, a CPU, a GPU, an I/O interface (e.g., a Serializer/Deserializer (SerDes) interface, transceiver, analog to digital convertor, digital to analog converter, and the like), a VD, a NoC, a MC or combinations thereof. Thus, the hardware accelerator 405 can be assigned to a different clock domain (or domains) from circuitry 425 that is on the same IC 400 as the accelerator 405. If the circuitry 425 includes a MC, the IC 400 can be coupled to a memory that is on a separate IC than the IC 400.

However, in another embodiment, the circuitry 425 can share the same clock domain as circuitry in the hardware accelerator 405. For example, the circuitry 425 can be in the clock domain 410A or 410B. For instance, the circuitry 425 can be in the same clock domain 410B as the circuitry 420.

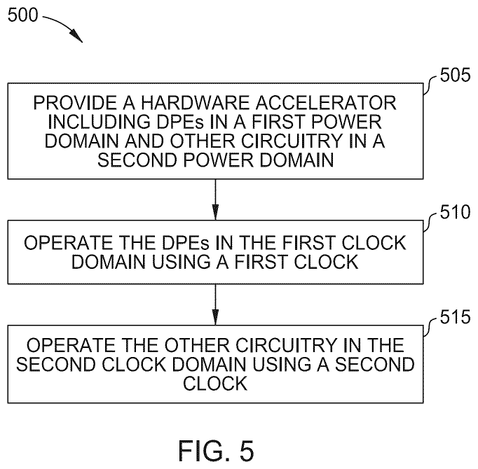

FIG. 5 illustrates a workflow of a method 500 for operating clock domains in a hardware accelerator, according to an example. At block 505, a hardware accelerator (e.g., the hardware accelerator 405 in FIG. 4 or the AI accelerator 120 in FIG. 1) is provided that includes DPEs in a first clock domain and other circuitry in a second clock domain. Because the DPEs are in a separate clock domain from the other circuitry (e.g., a controller, interconnect, IOMMU, etc.), the other circuit (e.g., interface circuitry tasked with moving data into and out of the hardware accelerator) can be driven using a different clock than the clock driving the DPEs. For example, the interface circuitry, such as the IOMMU, NoC, controller, etc., can be driven with a higher frequency clock to generate more bandwidth for moving data into and out of the AI the accelerator.

At block 510, the controller in the hardware accelerator (or a CPU or other logic in the same IC as the accelerator) operates the DPEs in the first clock domain using a first clock.

At block 515, the controller operates the circuitry in the second clock domain using a second clock that has a different frequency than the first clock. In one embodiment, the circuitry in the second clock domain is interface circuitry, such as the IOMMU 220 illustrated in FIG. 2A. In one embodiment, the second clock has a higher frequency than the first clock.

In one embodiment, the controller adjusts the second clock dynamically according to data movement demand. When the circuitry in the second clock domain has a lot of data (e.g., according to one or more thresholds) it is moving (or will move) into or out of the hardware accelerator, the controller may increase the frequency of the second clock. However, if the second domain does not have a lot of data to move into or out of the hardware accelerator the controller can reduce the clock frequency, e.g., to be the same as, or lower than, the first clock.

FIG. 6 is a block diagram of a data processing engine, according to an example. FIG. 6 is a block diagram of a DPE 210 in the AI engine array 205 illustrated in FIG. 2A or FIG. 2B, according to an example. The DPE 210 includes an interconnect 605, a core 610, and a memory module 630. The interconnect 605 permits data to be transferred from the core 610 and the memory module 630 to different cores in the array. That is, the interconnect 605 in each of the DPEs 210 may be connected to each other so that data can be transferred north and south (e.g., up and down) as well as east and west (e.g., right and left) between the DPEs 210 in the array.

For example, the DPEs 210 in an upper row of the array rely on the interconnects 605 in the DPEs 210 in a lower row to communicate with the NoC 215 shown in FIG. 2A and 2B. For example, to transmit data to the NoC, a core 610 in a DPE 210 in the upper row transmits data to its interconnect 605 which is in turn communicatively coupled to the interconnect 605 in the DPE 210 in the lower row. The interconnect 605 in the lower row is connected to the NoC. The process may be reversed where data intended for a DPE 210 in the upper row is first transmitted from the NoC to the interconnect 605 in the lower row and then to the interconnect 605 in the upper row that is the target DPE 210. In this manner, DPEs 210 in the upper rows may rely on the interconnects 605 in the DPEs 210 in the lower rows to transmit data to and receive data from the NoC.

In one embodiment, the interconnect 605 includes a configurable switching network that permits the user to determine how data is routed through the interconnect 605. In one embodiment, unlike in a packet routing network, the interconnect 605 may form streaming point-to-point connections. That is, the streaming connections and streaming interconnects (not shown in FIGS. 2A and 2B) in the interconnect 605 may form routes from the core 610 and the memory module 630 to the neighboring DPEs 210 or the NoC. Once configured, the core 610 and the memory module 630 can transmit and receive streaming data along those routes. In one embodiment, the interconnect 605 is configured using the AXI Streaming protocol. However, when communicating with the NoC, the DPEs 210 may use the AXI MM protocol.

In addition to forming a streaming network, the interconnect 605 may include a separate network for programming or configuring the hardware elements in the DPE 210. Although not shown, the interconnect 605 may include a memory mapped interconnect (e.g., AXI MM) which includes different connections and switch elements used to set values of configuration registers in the DPE 210 that alter or set functions of the streaming network, the core 610, and the memory module 630.

In one embodiment, streaming interconnects (or network) in the interconnect 605 support two different modes of operation referred to herein as circuit switching and packet switching. In one embodiment, both of these modes are part of, or compatible with, the same streaming protocol—e.g., an AXI Streaming protocol. Circuit switching relies on reserved point-to-point communication paths between a source DPE 210 to one or more destination DPEs 210. In one embodiment, the point-to-point communication path used when performing circuit switching in the interconnect 605 is not shared with other streams (regardless whether those streams are circuit switched or packet switched). However, when transmitting streaming data between two or more DPEs 210 using packet-switching, the same physical wires can be shared with other logical streams.

The core 610 may include hardware elements for processing digital signals. For example, the core 610 may be used to process signals related to wireless communication, radar, vector operations, machine learning applications, and the like. As such, the core 610 may include program memories, an instruction fetch/decode unit, fixed-point vector units, floating-point vector units, arithmetic logic units (ALUs), multiply accumulators (MAC), and the like. However, as mentioned above, this disclosure is not limited to DPEs 210. The hardware elements in the core 610 may change depending on the engine type. That is, the cores in an AI engine, digital signal processing engine, cryptographic engine, or FEC may be different.

The memory module 630 includes a DMA engine 615, memory banks 620, and hardware synchronization circuitry (HSC) 625 or other type of hardware synchronization block. In one embodiment, the DMA engine 615 enables data to be received by, and transmitted to, the interconnect 605. That is, the DMA engine 615 may be used to perform DMA reads and write to the memory banks 620 using data received via the interconnect 605 from the NoC or other DPEs 210 in the array.

The memory banks 620 can include any number of physical memory elements (e.g., SRAM). For example, the memory module 630 may be include 4, 8, 16, 32, etc. different memory banks 620. In this embodiment, the core 610 has a direct connection 635 to the memory banks 620. Stated differently, the core 610 can write data to, or read data from, the memory banks 620 without using the interconnect 605. That is, the direct connection 635 may be separate from the interconnect 605. In one embodiment, one or more wires in the direct connection 635 communicatively couple the core 610 to a memory interface in the memory module 630 which is in turn coupled to the memory banks 620.

In one embodiment, the memory module 630 also has direct connections 640 to cores in neighboring DPEs 210. Put differently, a neighboring DPE in the array can read data from, or write data into, the memory banks 620 using the direct neighbor connections 640 without relying on their interconnects or the interconnect 605 shown in FIG. 6. The HSC 625 can be used to govern or protect access to the memory banks 620. In one embodiment, before the core 610 or a core in a neighboring DPE can read data from, or write data into, the memory banks 620, the core (or the DMA engine 615) requests a lock acquire to the HSC 625 when it wants to read or write to the memory banks 620 (i.e., when the core/DMA engine want to “own” a buffer, which is an assigned portion of the memory banks 620. If the core or DMA engine does not acquire the lock, the HSC 625 will stall (e.g., stop) the core or DMA engine from accessing the memory banks 620. When the core or DMA engine is done with the buffer, they release the lock to the HSC 625. In one embodiment, the HSC 625 synchronizes the DMA engine 615 and core 610 in the same DPE 210 (i.e., memory banks 620 in one DPE 210 are shared between the DMA engine 615 and the core 610). Once the write is complete, the core (or the DMA engine 615) can release the lock which permits cores in neighboring DPEs to read the data.

Because the core 610 and the cores in neighboring DPEs 210 can directly access the memory module 630, the memory banks 620 can be considered as shared memory between the DPEs 210. That is, the neighboring DPEs can directly access the memory banks 620 in a similar way as the core 610 that is in the same DPE 210 as the memory banks 620. Thus, if the core 610 wants to transmit data to a core in a neighboring DPE, the core 610 can write the data into the memory bank 620. The neighboring DPE can then retrieve the data from the memory bank 620 and begin processing the data. In this manner, the cores in neighboring DPEs 210 can transfer data using the HSC 625 while avoiding the extra latency introduced when using the interconnects 605. In contrast, if the core 610 wants to transfer data to a non-neighboring DPE in the array (i.e., a DPE without a direct connection 640 to the memory module 630), the core 610 uses the interconnects 605 to route the data to the memory module of the target DPE which may take longer to complete because of the added latency of using the interconnect 605 and because the data is copied into the memory module of the target DPE rather than being read from a shared memory module.

In addition to sharing the memory modules 630, the core 610 can have a direct connection to cores 610 in neighboring DPEs 210 using a core-to-core communication link (not shown). That is, instead of using either a shared memory module 630 or the interconnect 605, the core 610 can transmit data to another core in the array directly without storing the data in a memory module 630 or using the interconnect 605 (which can have buffers or other queues). For example, communicating using the core-to-core communication links may use less latency (or have high bandwidth) than transmitting data using the interconnect 605 or shared memory (which requires a core to write the data and then another core to read the data) which can offer more cost effective communication. In one embodiment, the core-to-core communication links can transmit data between two cores 610 in one clock cycle. In one embodiment, the data is transmitted between the cores on the link without being stored in any memory elements external to the cores 610. In one embodiment, the core 610 can transmit a data word or vector to a neighboring core using the links every clock cycle, but this is not a requirement.

In one embodiment, the communication links are streaming data links which permit the core 610 to stream data to a neighboring core. Further, the core 610 can include any number of communication links which can extend to different cores in the array. In this example, the DPE 210 has respective core-to-core communication links to cores located in DPEs in the array that are to the right and left (east and west) and up and down (north or south) of the core 610. However, in other embodiments, the core 610 in the DPE 210 illustrated in FIG. 6 may also have core-to-core communication links to cores disposed at a diagonal from the core 610. Further, if the core 610 is disposed at a bottom periphery or edge of the array, the core may have core-to-core communication links to only the cores to the left, right, and bottom of the core 610.

However, using shared memory in the memory module 630 or the core-to-core communication links may be available if the destination of the data generated by the core 610 is a neighboring core or DPE. For example, if the data is destined for a non-neighboring DPE (i.e., any DPE that DPE 210 does not have a direct neighboring connection 640 or a core-to-core communication link), the core 610 uses the interconnects 605 in the DPEs to route the data to the appropriate destination. As mentioned above, the interconnects 605 in the DPEs 210 may be configured when the SoC is being booted up to establish point-to-point streaming connections to non-neighboring DPEs to which the core 610 will transmit data during operation.

FIG. 7 is a block diagram of an AI engine array 205, according to an example. In this example, AI engine array 205 includes a plurality of circuit blocks, or tiles, illustrated here as the DPEs 210 (also referred to as DPE tiles or compute tiles), interface tiles 704, and memory tiles 706. Memory tiles 706 may be referred to as shared memory and/or shared memory tiles. Interface tiles 704 may be referred to as shim tiles, and may be collectively referred to as an array interface 728. Like in FIGS. 2A and 2B, the AI engine array 205 is coupled to the NoC 215. FIG. 7 further illustrates that the interface tiles 704 communicatively couple the other tiles in the AI engine array 205 (i.e., the DPEs 210 and memory tiles 706) to the NoC 215.

In one embodiment, the DPEs 210, memory tiles 706, and the interface tiles 704 are in the same power or clock domain. However, in another embodiment, the DPEs 210 may be in one power or clock domain while the memory tiles 706 and the interface tiles 704 are in another embodiment. This permits the controller to disable the DPEs 210 while the memory tiles 706 and interface tiles 704 remain operational, and vice versa. In yet another embodiment, the DPEs 210, memory tiles 706, and the interface tiles 704 may each be in their own power or clock domains.

DPEs 210 can include one or more processing cores, program memory (PM), data memory (DM), DMA circuitry, and stream interconnect (SI) circuitry, which are also described in FIG. 4. For example, the core(s) is the DPEs 210 can execute program code stored in the PM. The core(s) may include, without limitation, a scalar processor and/or a vector processor. DM may be referred to herein as local memory or local data memory, in contrast to the memory tiles which have memory that is external to the DPE tiles, but still within the AI engine array 205.

The core(s) may directly access data memory of other DPE tiles via DMA circuitry. The core(s) may also access DM of adjacent (or neighboring) DPEs 210 via DMA circuitry and/or DMA circuitry of the adjacent compute tiles. In one embodiment, DM in one DPE 210 and DM of adjacent DPE tiles may be presented to the core(s) as a unified region of memory. In one embodiment, the core(s) in one DPE 210 may access data memory of non-adjacent DPEs 210. Permitting cores to access data memory of other DPE tiles may be useful to share data amongst the DPEs 210.

The AI engine array 205 may include direct core-to-core cascade connections (not shown) amongst DPEs 210. Direct core-to-core cascade connections may include unidirectional and/or bidirectional direct connections. Core-to-core cascade connections may be useful to share data amongst cores of the DPEs 210 with relatively low latency (e.g., the data does not traverse stream interconnect circuitry such as the interconnect 605 in FIG. 6, and the data does not need to be written to data memory of an originating DPE and read by a recipient or destination DPE). For example, a direct core-to-core cascade connection may be useful to provide results from an accumulation register of a processing core of an originating DPE directly to a processing core(s) of a destination DPE.

In an embodiment, DPEs 210 do not include cache memory. Omitting cache memory may be useful to provide predictable/deterministic performance. Omitting cache memory may also be useful to reduce processing overhead associated with maintaining coherency among cache memories across the DPEs 210.

In an embodiment, processing cores of the DPE 210 do not utilize input interrupts. Omitting interrupts may be useful to permit the processing cores to operate uninterrupted. Omitting interrupts may also be useful to provide predictable and/or deterministic performance.

One or more DPEs 210 may include special purpose or specialized circuitry, or may be configured as special purpose or specialized compute tiles such as, without limitation, digital signal processing engines, cryptographic engines, forward error correction (FEC) engines, and/or artificial intelligence (AI) engines.

In an embodiment, the DPEs 210, or a subset thereof, are substantially identically to one another (i.e., homogenous compute tiles). Alternatively, one or more DPEs 210 may differ from one other more other DPEs 210 (i.e., heterogeneous compute tiles).

Memory tile 706-1 includes memory 718 (e.g., random access memory or RAM), DMA circuitry 720, and stream interconnect (SI) circuitry 722.

Memory tile 706-1 may lack or omit computational components such as an instruction processor. In an embodiment, memory tiles 706, or a subset thereof, are substantially identical to one another (i.e., homogenous memory tiles). Alternatively, one or more memory tiles 706 may differ from one other more other memory tiles 706 (i.e., heterogeneous memory tiles). A memory tile 706 may be accessible to multiple DPEs 210. Memory tiles 706 may thus be referred to as shared memory.

Data may be moved between/amongst memory tiles 706 via DMA circuitry 720 and/or stream interconnect circuitry 722 of the respective memory tiles 706. Data may also be moved between/amongst data memory of a DPE 210 and memory 718 of a memory tile 706 via DMA circuitry and/or stream interconnect circuitry of the respective tiles. For example, DMA circuitry in a DPE 210 may read data from its data memory and forward the data to memory tile 706-1 in a write command, via stream interconnect circuitry in the DPE 210 and stream interconnect circuitry 722 in the memory tile 706. DMA circuitry 724 of memory tile 706-1 may then write the data to memory 718. As another example, DMA circuitry 720 of memory tile 706-1 may read data from memory 718 and forward the data to a DPE 210 in a write command, via stream interconnect circuitry 722 and stream interconnect circuitry in the DPE 210, and DMA circuitry in the DPE 210 can write the data to its data memory.

Array interface 728 interfaces between the AI engine array 205 (e.g., DPEs 210 and memory tiles 706) and the NoC 215. Interface tile 704-1 includes DMA circuitry 724 and stream interconnect circuitry 726. Interface tiles 704 may be interconnected so that data may be propagated amongst interface tiles 704 bi-directionally. An interface tile 704 may operate as an interface for column of DPEs 210 (e.g., as an interface to the NoC 215). Interface tiles 704 may be connected such that data may be propagated from one interface tile 704 to another interface tile 704 bi-directionally.

In an embodiment, interface tiles 704, or a subset thereof, are substantially identically to one another (i.e., homogenous interface tiles). Alternatively, one or more interface tiles 704 may differ from one other more other interface tiles 704 (i.e., heterogeneous interface tiles).

In an embodiment, one or more interface tiles 704 is configured as a NoC interface tile (e.g., as master and/or slave device) that interfaces between the DPEs 210 and the NoC 215 (e.g., to access other components in the SoC). While FIG. 7 illustrates coupling a subset of the interface tiles 704 to the NoC 215, in one embodiment, each of the interface tiles 704-1-5 is connected to the NoC 215. Doing so may permit different applications to control and use different columns of the memory tiles 706 and DPEs 210.

DMA circuitry and stream interconnect circuitry of the AI engine array 205 may be configurable/programmable to provide desired functionality and/or connections to move data between/amongst DPEs 210, memory tiles 706, and the NoC 215. The DMA circuitry and stream interconnect circuitry of the AI engine array 205 may include, without limitation, switches and/or multiplexers that are configurable to establish signal paths within, amongst, and/or between tiles of the AI engine array 205. The AI engine array 205 may further include configurable AXI interface circuitry. The DMA circuitry, the stream interconnect circuitry, and/or AXI interface circuitry may be configured or programmed by storing configuration parameters in configuration registers, configuration memory (e.g., configuration random access memory or CRAM), and/or eFuses, and coupling read outputs of the configuration registers, CRAM, and/or eFuses to functional circuitry (e.g., to a control input of a multiplexer or switch), to maintain the functional circuitry in a desired configuration or state. In an embodiment, the core(s) of DPEs 210 configure the DMA circuitry and stream interconnect circuitry of the respective DPEs 210 based on core code stored in PM of the respective DPEs 210. A controller (not shown) can configure DMA circuitry and stream interconnect circuitry of memory tiles 706 and interface tiles 704 based on controller code.

The AI engine array 205 may include a hierarchical memory structure. For example, data memory of the DPEs 210 may represent a first level (L1) of memory, memory 718 of memory tiles 706 may represent a second level (L2) of memory, and external memory outside the AI engine array 205 may represent a third level (L3) of memory. Memory capacity may progressively decrease with each level (e.g., memory 718 of memory tile 706 may have more storage capacity than data memory in the DPEs 210, and external memory may have more storage capacity than data memory 718 of the memory tiles 706). The hierarchical memory structure is not, however, limited to the foregoing examples.

As an example, an input tensor may be relatively large (e.g., 1 megabyte or MB). Local data memory in the DPEs 210 may be significantly smaller (e.g., 64 kilobytes or KB). The controller may segment an input tensor and store the segments in respective blocks of shared memory tiles 706.

In the preceding, reference is made to embodiments presented in this disclosure. However, the scope of the present disclosure is not limited to specific described embodiments. Instead, any combination of the described features and elements, whether related to different embodiments or not, is contemplated to implement and practice contemplated embodiments. Furthermore, although embodiments disclosed herein may achieve advantages over other possible solutions or over the prior art, whether or not a particular advantage is achieved by a given embodiment is not limiting of the scope of the present disclosure. Thus, the preceding aspects, features, embodiments and advantages are merely illustrative and are not considered elements or limitations of the appended claims except where explicitly recited in a claim(s).

As will be appreciated by one skilled in the art, the embodiments disclosed herein may be embodied as a system, method or computer program product. Accordingly, aspects may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium is any tangible medium that can contain, or store a program for use by or in connection with an instruction execution system, apparatus or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present disclosure may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present disclosure are described below with reference to flowchart illustrations and/or block diagrams of methods, apparatus (systems) and computer program products according to embodiments presented in this disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods, and computer program products according to various examples of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

While the foregoing is directed to specific examples, other and further examples may be devised without departing from the basic scope thereof, and the scope thereof is determined by the claims that follow.

What is claimed is:

1. A system on a chip (SoC), comprising:
a hardware accelerator comprising data processing engines (DPEs) and interface circuitry, wherein the DPEs are in a first clock domain that uses a first clock and the interface circuitry is in a second clock domain that uses a second clock with a different frequency than the first clock; and
an interface communicatively coupling the hardware accelerator to other circuitry in the SoC.

2. The SoC of claim 1, wherein the interface circuitry in the second clock domain comprises:
an Input-Output Memory Management Unit (IOMMU) comprising circuitry configured to perform a physical to virtual address translation.

3. The SoC of claim 2, wherein the other circuitry comprises at least one central processing unit (CPU), wherein the IOMMU is configured to translate virtual addresses used by the hardware accelerator to physical addresses used by the at least one CPU before transmitting data from the hardware accelerator to the interface.

4. The SoC of claim 3, wherein the CPU is in a different clock domain than the first clock domain.

5. The SoC of claim 4, wherein the CPU is in a third clock domain that is separate from the first and second clock domains.

6. The SoC of claim 2, wherein the interface circuitry further comprises a controller and a network on chip (NoC), wherein the controller and the IOMMU communicate with the DPEs through the NoC.

7. The SoC of claim 6, wherein the controller communicates with a CPU only through the interface, wherein the interface is a second NoC, wherein the second NoC is larger than the NoC in the hardware accelerator.

8. The SoC of claim 1, wherein the interface circuitry is configured to move data into and out of the hardware accelerator via the interface, wherein the second clock has a higher frequency than the first clock.

9. The SoC of claim 8, wherein the SoC is configured to increase and decrease a frequency of the second clock in response to data movement demands corresponding to the interface circuitry.

10. The SoC of claim 1, wherein the DPEs are arranged in an array, wherein each of the DPEs comprises a core, a memory module, and an interconnect, wherein the interconnects in the DPEs are interconnected so that the DPEs are able to transmit data between each other.

11. A method, comprising:
providing a hardware accelerator comprising DPEs in a first clock domain and interface circuitry in a second clock domain;
operating a first clock in the first clock domain at a first frequency; and
operating a second clock in the second clock domain at a second frequency different from the first frequency.

12. The method of claim 11, wherein the interface circuitry in the second clock domain comprises:
an IOMMU comprising circuitry configured to perform a physical to virtual address translation.

13. The method of claim 12, further comprising:
translating, using the IOMMU, virtual addresses used by the hardware accelerator to physical addresses used by a CPU before transmitting data from the hardware accelerator to the CPU, wherein the CPU is in a same SoC as the hardware accelerator.

14. The method of claim 13, wherein the CPU is in a different clock domain than the first clock domain.

15. The method of claim 14, wherein the CPU is in a third clock domain that is separate from the first and second clock domains.

16. The method of claim 11, wherein the hardware accelerator is at least one of an artificial intelligence (AI) accelerator, a cryptography accelerator, or a compression accelerator.

17. A system, comprising:
an IC, comprising:
a hardware accelerator comprising first circuitry in a first clock domain and interface circuitry in a second clock domain, wherein, during operation, a first clock in the first clock domain has lower frequency than a second clock in the second clock domain, and
a memory controller; and
at least one memory coupled to the memory controller in the IC.

18. The system of claim 17, wherein the interface circuitry in the second clock domain comprises:
an IOMMU comprising circuitry configured to perform a physical to virtual address translation.

19. The system of claim 18, wherein the IC comprises a CPU and an interconnect, wherein the interconnect couples the CPU to a controller in the hardware accelerator and the IOMMU in the hardware accelerator.

20. The system of claim 17, wherein the first circuitry comprises DPEs arranged in an array, wherein each of the DPEs comprises a core, a memory module, and an interconnect, wherein the interconnects in the DPEs are interconnected so that the DPEs are able to transmit data between each other.
